(19) United States
(12) Patent Application Publication
(10) Pub. No.: US 2009/0054118 A1
(43) Pub. Date: Feb. 26, 2009

(54) GAMING APPARATUS EXECUTING RACE BY A PLURALITY OF RACE OBJECTS, AND GAME CONTROL METHOD THEREOF

(75) Inventor: Hiroki Saito, Kotu-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Kotu-ku (JP)

(21) Appl. No.: 12/183,417

(22) Filed: Jul. 31, 2008

(30) Foreign Application Priority Data
Aug. 22, 2007 (JP) 2007-216227

(51) Int. Cl. A63F 13/00

(52) U.S. Cl. 463/6; 463/37

(57) ABSTRACT

The gaming apparatus of the present invention is provided with a display and a side display. According to the present invention, when a command to play a side game which is different from a racing game is inputted during the time when the racing game is proceeding or during the time from the end of one racing game before the start of a next racing game, the side game is executed at a station where the command has been inputted. An image relating to the side game is then displayed to the side display provided in the station.

### CROSS-REFERENCE TO RELATED APPLICATIONS

This application claims benefit of priority based on Japanese Patent Application No. 2007-216227 filed on Aug. 22, 2007. The contents of this application are incorporated herein by reference in their entirety.

### BACKGROUND OF THE INVENTION

### Field of the Invention

The present invention relates to a gaming apparatus that executes a race by a plurality of race objects, and a game control method thereof.

Conventionally, there have been known gaming apparatuses for execution of a racing game in which a plurality of race objects contend with one another for winning, such as horse racing game apparatuses (see U.S. Pat. No. 6,210,275, U.S. Pat. No. 6,358,150, U.S. Pat. No. 6,450,887, U.S. Pat. No. 6,634,944, JP-A2001-87461, U.S. Pat. No. 6,848,991, JP-B3291287, U.S. Pat. No. 6,905,410, JP-B 3366308, U.S. Pat. No. 6,921,331, U.S. Pat. No. 6,929,550, JP-A 2002-85852, U.S. Pat. No. 6,962,529, JP-A 2002-035429, U.S. Pat. No. 7,025,353, and U.S. Pat. No. 7,172,508). In general, a player who plays on the gaming apparatus of this kind predicts which race object will win based on information provided from the gaming apparatus or intuitive prediction, and bets game media such as medals on the race object. Thereafter, the player can receive a payout depending on the result of the race and the betted game media.

Recently, for example, a horse racing game apparatus has been introduced which displays an image of a paddock or the like to show the player conditions of horses before they run, so as to provide the player an opportunity to carefully select which horse to bet on.

In actual horse racing, determination on which horse to bet on is made after examining a condition of each horse on the day of the race as well as basic abilities of the horse such as speed and stamina. According to the horse racing game apparatus of the aforementioned type, it becomes possible to provide a horse racing game with abundant realness.

The contents of U.S. Pat. No. 6,210,275, U.S. Pat. No. 6,358,150, U.S. Pat. No. 6,450,887, U.S. Pat. No. 6,634,944, JP-A 2001-87461, U.S. Pat. No. 6,848,991, JP-B 3291287, U.S. Pat. No. 6,905,410, JP-B 3366308, U.S. Pat. No. 6,921,331, U.S. Pat. No. 6,929,550, JP-A 2002-85852, U.S. Pat. No. 6,962,529, JP-A 2002-035429, U.S. Pat. No. 7,025,353, and U.S. Pat. No. 7,172,508 are incorporated herein by reference in their entirety.

According to the horse racing game apparatus as described above, a relatively long period of time is taken for the player to place a BET. Hence there has been a problem that those players not having a high interest in carefully choosing a horse to bet on would feel the BET time is too long, and thus get bored. Some of those players who get bored play a game on another gaming apparatus inside a gaming facility during the BET time, but in such a case, the players often leave the horse racing game apparatus with coins left credited, and thus they might have their coins stolen.

The present invention was made in view of the foregoing problem, and has an object to provide a gaming apparatus and a game control method which are capable of preventing a player from getting bored and preventing coins or the like from being stolen.

### SUMMARY OF THE INVENTION

In order to solve the foregoing problems, the present invention provides the following.

(1) A gaming apparatus, comprising:

a display capable of displaying an image relating to a racing game in which a plurality of race objects contend with one another for winning;

one or a plurality of stations at least having a side display capable of displaying an image relating to a side game which is different from the racing game and an input device with which a player can input a command; and

a controller,

the controller programmed to execute the processing of

(A) proceeding with the racing game,

(B) displaying to the display an image relating to the racing game which proceeds in execution of the processing (A),

(C) executing, when a command to play the side game is inputted from the input device during the time when the racing game executed in the processing (A) is proceeding or during the time from the end of one racing game before the start of a next racing game, the side game in the station having the input device, and

(D) displaying an image relating to the side game executed in the processing (C) to the side display provided in the station.

According to the invention of (1), a gaming apparatus includes a display and a side display. A racing game in which a plurality of race objects (e.g. racehorses in a horse racing game) contend with each other for winning proceeds, and an image relating to the racing game is displayed to a display.

Meanwhile, when a command to play a side game which is different from the racing game is inputted during the time when the racing game is proceeding (during the time from the start to the finish of racehorses) or during the time from the end of one racing game before the start of a next racing game (e.g. when an image showing a paddock is displayed during a BET period), the side game is executed at the station where the command was inputted. An image relating to the side game is then displayed to a side display provided in each station.

According to the invention of (1), for example, a player who has completed a BET input before the end of the BET period due to little interest in carefully selecting a horse to bet on, or a player who is not interested in the intermediate status of a race and just wants to know a race result (i.e. a player having a primary interest in a payout of game media), can play a side game at his or her option by looking at an image relating to the side game displayed to the side display provided in the station. It is therefore possible to prevent such a player from getting bored.

Further, since the player can enjoy the side game, the player less often leaves the racing gaming apparatus with coins left credited to play a game in another gaming apparatus. It is thus possible to prevent the player from having the credited coins stolen.

Further, the present invention provides the following.

(2) The gaming apparatus according to the above-mentioned (1),

wherein

the display is provided in each of the stations.

According to the invention of (2), the station has both the display to which the image relating to the racing game is displayed and the side display to which the image relating to the side game is displayed. Therefore, it is possible for the player to simultaneously have the image relating to the racing game and the image relating to the side game in sight, and thus not necessary to shift his or her eyes between a display (c.f. big screen) installed at a place other than the station and the side display provided in the station, so as to always grasp with precision the status of both the racing game and the side game. It is therefore possible to prevent the player from missing an important scene such as the goal of the racehorses.

Further, according to the invention of (2), since the display is provided in each station, each player can operate the input device, to make a scene he or she wishes to see displayed to the display. For example, the player can make an image, showing a condition of a racehorse of his or her interest in a paddock, displayed to the display. As thus described, according to the invention of (2), it is possible to display an image meeting each player's request, so as to provide the player with satisfaction.

Further, the present invention provides the following. (3) The gaming apparatus according to the above-mentioned (1), wherein

the input device is an input device with which a player can input a BET on the racing game and the side game,

the controller is further programmed to execute processing of:

(A′) accepting a BET on the racing game from each of the input devices; and

(C′) accepting a BET on the side game from the input device, from which the BET on the racing game was inputted in the processing (A′), in the station having the input device, and

the processing (C) is processing of executing, on condition that the BET has been placed on the side game from the input device in said processing (C′), the side game in the station having the input device, from which the BET on the side game was inputted.

According to the invention of (3), a BET on the side game is accepted only at the station where a BET has been placed on the racing game. The side game is then executed on condition that the BET has been placed on the side game.

Therefore, only a player who has placed a BET on the racing game can play the side game. It is there by possible to eliminate a player who intends to play only the side game, so as to prevent a player who concentrates on the racing game from being offended, while avoiding a state in which the gaming apparatuses are exclusively used by players who play only the side game and thus other players cannot participate in the racing game.

Further, the present invention provides the following. (4) A game control method, comprising the steps of:

(A) proceeding with a racing game in which a plurality of race objects contend with one another for winning;

(B) displaying to a display an image relating to the racing game which proceeds in execution of the step (A);

(C) executing a side game which is different from the racing game in a station into which a command to play the side game has been inputted when the command is inputted during the time when the racing game executed in the step (A) is proceeding or during the time from the end of one racing game before the start of a next racing game; and

(D) displaying an image relating to the side game executed in the step (C) to a side display which is different from the display and is provided in the station.

According to the invention of (4), a gaming apparatus includes a display and a side display. A racing game in which a plurality of race objects (e.g. racehorses in a horse racing game) contend with each other for winning proceeds, and an image relating to the racing game is displayed to a display.

Meanwhile, when a command to play a side game which is different from the racing game is inputted during the time when the racing game is proceeding (during the time from the start to the finish of racehorses) or during the time from the end of one racing game before the start of a next racing game (e.g. when an image showing a paddock is displayed during a BET period), the side game is executed at the station where the command was inputted. An image relating to the side game is then displayed to a side display provided in each station.

According to the invention of (4), for example, a player who has completed a BET input before the end of the BET period due to little interest in carefully selecting a horse to bet on, or a player who is not interested in the intermediate status of a race and just wants to know a race result (i.e. a player having a primary interest in a payout of game media), can play a side game at his or her option by looking at an image relating to the side game displayed to the side display provided in the station. It is therefore possible to prevent such a player from getting bored.

Further, since the player can enjoy the side game, the player less often leaves the racing gaming apparatus with coins left credited to play a game in another gaming apparatus. It is thus possible to prevent the player from having the credited coins stolen.

Further, the present invention provides the following.

(5) The game control method according to the above-mentioned (4), including the steps of:

(A′) accepting a BET on the racing game; and

(C′) accepting a BET on the side game in a station where the BET has been placed on the racing game in the step (A′),

wherein

the step (C) is a step of executing the side game in the station where the BET has been placed on the side game on condition that the BET has been placed on the side game in the step (C′).

According to the invention of (5), a BET on the side game is accepted only at the station where a BET has been placed on the racing game. The side game is then executed on condition that the BET has been placed on the side game.

Therefore, only a player who has placed a BET on the racing game can play the side game. It is there by possible to eliminate a player who intends to play only the side game, so as to prevent a player who concentrates on the racing game from being offended, while avoiding a state in which the gaming apparatuses are exclusively used by players who play only the side game and thus other players cannot participate in the racing game.

According to the present invention, it is possible to provide a gaming apparatus and a game control method which are capable of preventing a player from getting bored and also capable of preventing coins or the like from being stolen.

### BRIEF DESCRIPTION OF THE DRAWINGS

FIGS. 1(a) and 1(b) are views showing one example of images displayed to a sub monitor provided in a station of a horse racing game apparatus according to the embodiment of the present invention.

FIG. 2 is a perspective view schematically showing an example of the horse racing game apparatus according to the present embodiment.

FIG. 3 is a perspective view schematically showing an example of the stations shown in FIG. 2.

FIG. 4 is a block diagram showing an internal configuration of a main game portion provided in the horse racing game apparatus shown in FIG. 2.

FIG. 5 is a block diagram showing an internal configuration of a station provided in the horse racing game apparatus shown in FIG. 2.

FIG. 6 is a view schematically showing one example of BET images displayed to the sub-monitor.

FIG. 7 is a flowchart showing an example of game operations in the horse racing game apparatus in the present embodiment.

FIG. 8 is a flowchart showing an example of game operations in the horse racing game apparatus in the present embodiment.

FIG. 9 is a view showing a time table for the horse racing game and a bingo game.

FIG. 10 is a flowchart showing a subroutine of bingo game execution processing performed in the sub control portion.

FIG. 11 is a flowchart showing a subroutine of racing game execution processing performed in the sub control portion.

### DESCRIPTION OF THE EMBODIMENTS

An embodiment of the present invention is described based on the drawings. In the following, the case of applying the present invention to a horse racing game apparatus is described as a preferred embodiment of the present invention.

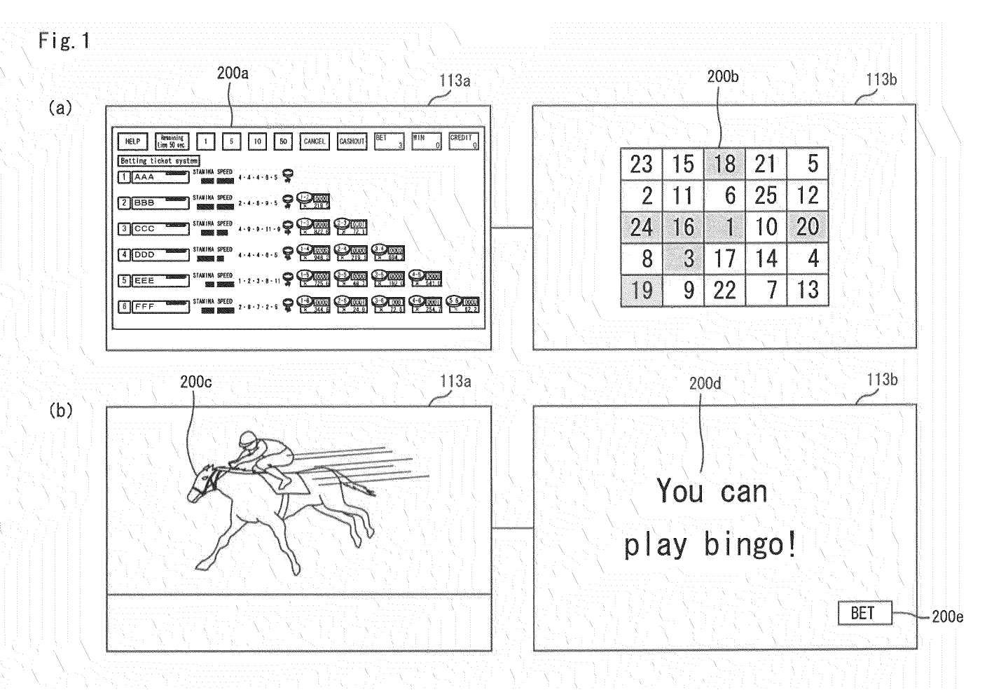

FIGS. 1A and B are views each showing an example of images displayed to a sub-monitor provided in a station provided in a horse racing game apparatus according to the present embodiment.

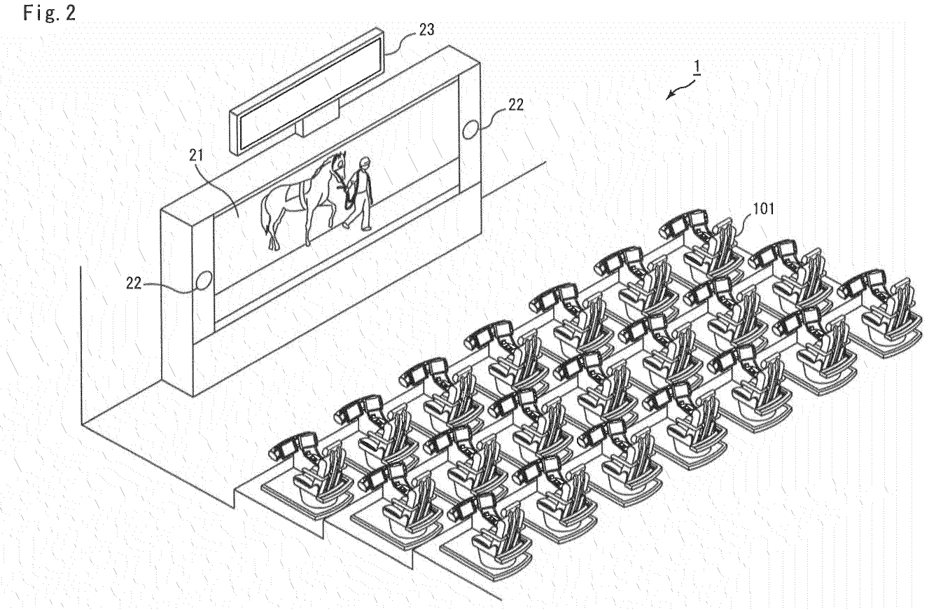

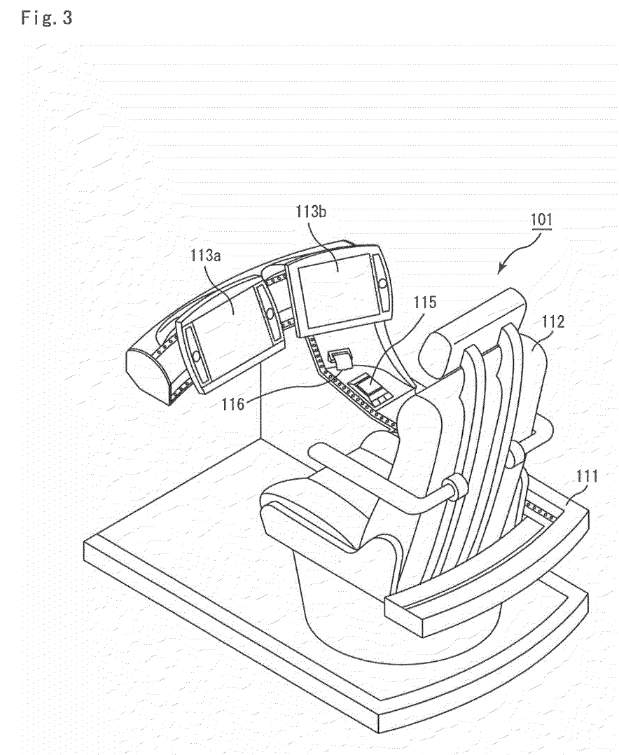

A horse racing game apparatus 1 according to the present embodiment includes a plurality of stations 101 where each of a plurality of players can input a command (e.g. BET) regarding a horse racing game, to play the horse racing game (see FIG. 2). Further, each station 101 is provided with two sub-monitors, 113a and 113b (see FIG. 3). The images shown in FIG. 1 are displayed to the sub-monitors 113a and 113b.

In a horse racing game apparatus 1, a race is held in which a plurality of virtual racehorses contend with one another for winning. The player predicts which racehorse will win, and places a BET. The racehorse corresponds to the race object in the present invention, and the race corresponds to the racing game in the present invention. In the present embodiment, a combination of betting by the player and the race (racing game) by racehorses is referred to as a horse racing game.

In the present embodiment, while the horse racing game is played in the horse racing game apparatus 1, a bingo game is played at the station 101 provided in the horse racing game apparatus 1. The bingo game corresponds to the side game in the present invention.

When the image relating to the horse racing game is displayed to the sub-monitor 113a, the image relating to a bingo game is displayed to the sub-monitor 113b. The sub-monitor 113a corresponds to the display in the present invention, and the sub-monitor 113b corresponds to the side display in the present invention.

The player can play the bingo game at a prescribed timing during a period when a BET can be placed on the horse racing game (hereinafter also referred to as during a BET period) and during a period when the racehorses run the race (hereinafter also referred to as during a race).

FIG. 1A is an example of images displayed to the sub-monitors 113a and 113b during the BET period. Further, FIG. 1B shows an example of images displayed to the sub-monitors 113a and 113b during the race.

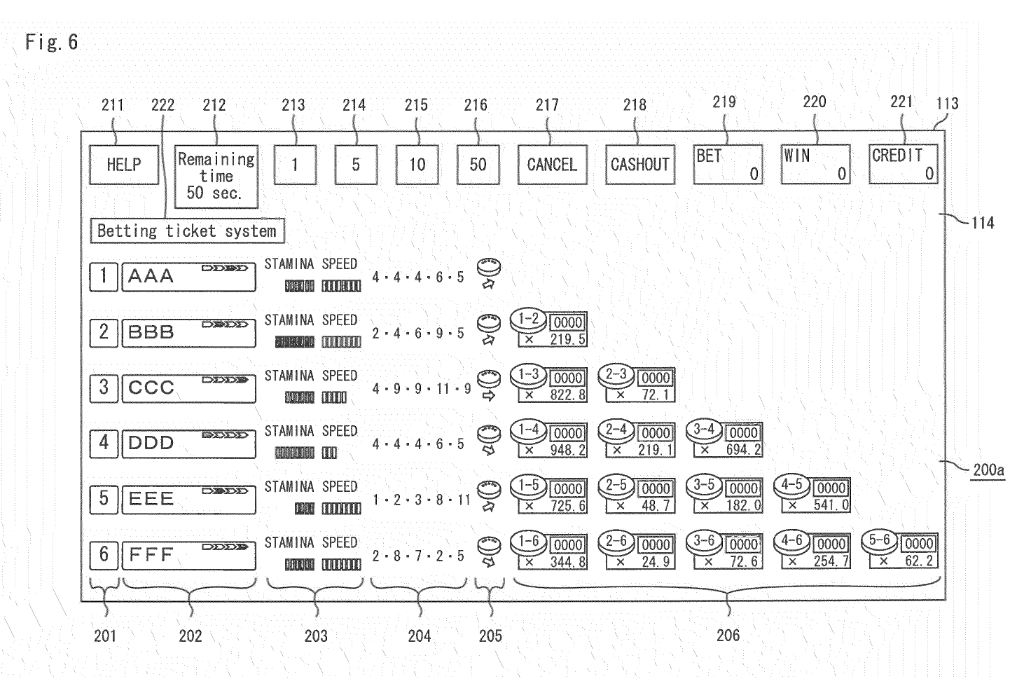

On the sub-monitor 113a shown in FIG. 1A, a BET image 200a (see FIG. 6) is displayed. The player can operate this BET image 200a through a touch panel, to place a BET on the horse racing game.

Meanwhile, on the sub-monitor 113b shown in FIG. 1A, a bingo image 200b showing a status of the bingo game being played is displayed. The bingo image 200b is an image on which numbers are respectively arranged in cells of five rows and five columns. In the bingo game, numbers are successively determined one by one. Then a display mode of the cell where the determined number is arranged changes. When a combination of the cells the display modes of which have changed satisfies a prescribed condition (when forming a vertical, horizontal or oblique line), a payout is offered. The status that a combination of cells the display modes of which have changed satisfies a prescribed condition can be also referred to as “a bingo is established” in the present embodiment.

On the sub-monitor 113a shown in FIG. 1B, a race image 200c showing a status of a race is displayed.

Meanwhile, on the sub-monitor 113b shown in FIG. 1B, a notification image 200d to notify a player that the bingo game can be played, and a bingo BET button image 200e are displayed. The player can operate a touch panel on the bingo BET button image 200e, to place a BET on the bingo game, so as to play the bingo game.

It is to be noted that the notification image 200d and the bingo BET button image 200e are displayed only when the player places a BET on the horse racing game. Namely, in the present embodiment, the player can play the bingo game only when placing a BET on the horse racing game.

FIG. 2 is a perspective view schematically showing an example of the horse racing game apparatus according to the present embodiment. The horse racing game apparatus 1 includes a main monitor 21, a speaker 22 installed at both of the right and the left sides of the main monitor 21, and an indicator 23 installed at the upper side of the main monitor, and a plurality of the stations 101 installed so as to face the main monitor 21.

An image showing status of races, images showing information based on BET and the like are displayed to the main monitor 21. The example of FIG. 2 shows a paddock image showing a paddock displayed during the BET period. The main monitor 21 constitutes the display which is capable of displaying an image relating to the racing game in the present invention, along with the sub-monitor 113a.

The speaker 22 outputs a sound corresponding to the status of races. General information relating to the game is displayed to the indicator 23.

FIG. 3 is a perspective view schematically showing an example of the station shown in FIG. 2.

The station 101 has: a cabinet 111, a chair 112 installed inside the cabinet 111; a sub monitor 113 installed on the cabinet 111 so as to face the chair 112; touch panels 114a and 114b (not shown) installed on the screen of the sub monitors 113a and 113b; a bill validator 115 installed on the cabinet 111 to the right of the chair 112; and a ticket printer 116 installed in front of the bill validator 115.

As described above, to the sub-monitor 113a, images regarding the horse racing game such as the BET image 200a and the race image 200c are displayed. Further, to the sub-monitor 113b, images regarding the bingo game, such as the bingo image 200b, the notification image 200d and the bingo BET button image 200e, are displayed.

The touch panel 114a is operated by the player when placing a BET on the horse racing game. Further, the touch panel 114b is operated by the player when placing a BET on the bingo game. The touch panel 114a and the touch panel 114b correspond to the input device in the present invention.

The bill validator 115 identifies validity of a bill, and accepts a regular bill into the cabinet 111. The bill accepted into the cabinet 111 is converted into the number of coins at a prescribed rate, and the number of credits corresponding to the number of coins is added to the number of credits owned by the player. It is to be noted that the bill validator 115 may be configured so as to be capable of reading a later-described ticket 39 with a barcode.

The ticket printer 116 prints on a ticket a barcode formed by encoding data such as the number of credits, date and time, and an identification number of the station 101, and outputs the ticket as the ticket 39 with a barcode. The player can make another station read the ticket 39 with a barcode and play a game on that station 101, or exchange the ticket 39 with a barcode with bills or the like at a prescribed place in a gaming facility (e.g. cashier booth in a casino).

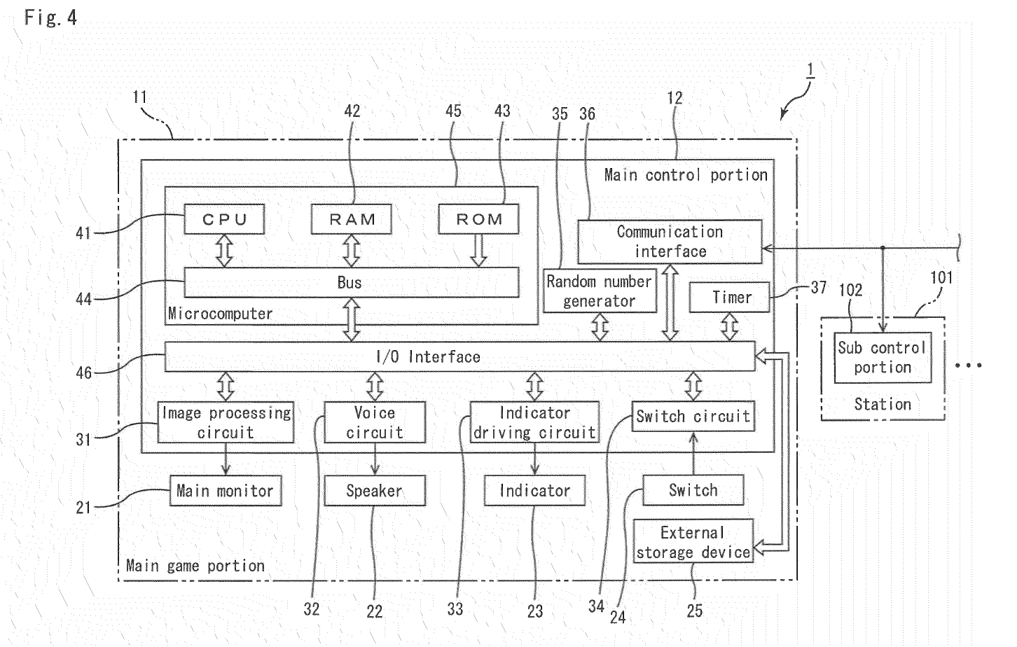

FIG. 4 is a block diagram showing an internal configuration of a main game portion provided in the horse racing game apparatus shown in FIG. 2.

A main game portion 11 is a central portion of the horse racing game apparatus 1 in the present embodiment. The main game portion 11 has a main control portion 12, the main monitor 21, the speakers 22, the indicator 23, a switch 24, and an external storage device 25.

The main control portion 12 has a microcomputer 45, arranged on a circuit board, as a main constituent. The microcomputer 45 has a CPU 41 that performs a control operation in accordance with a previously set program, a RAM 42, and a ROM 43.

The RAM 42 is a memory for temporarily storing a variety of data computed in the CPU 41. The ROM 43 stores a variety of programs for performing processing necessary in controlling the horse racing game apparatus 1, information regarding a plurality of racehorses, data on winning percentage of each racehorse, and the like.

The microcomputer 45 is connected with an image processing circuit 31 through an I/O interface 46. The image processing circuit 31 is connected to the main monitor 21, and controls the drive of the main monitor 21.

The image processing circuit 31 has a program ROM 311, an image ROM 312, an image control CPU 313, a work RAM 314, an image data processor 315 (hereinafter also referred to as a “VDP 315”), and a video RAM 316.

The program ROM 311 stores a program for image control regarding display within the main monitor 21, and a variety of selection tables.

Further, the image ROM 312 stores, for example, dot data for forming an image within the main monitor 21 and a variety of image data such as background image data and image data of racehorses.

Further, the image control CPU 313 determines an image to be displayed to the main monitor 21 out of the dot data and image data previously stored inside the image ROM in accordance with the image control program previously stored inside the program ROM, based on a parameter set in the microcomputer 45.

Further, the work RAM 314 is configured as a temporary storage unit in execution of the image control program in the image control CPU 313.

Furthermore, the VDP 315 generates image data in accordance with display contents determined in the image control CPU 313, and outputs the data to the main monitor 21.

Moreover, the video RAM 316 is configured as a temporary storage unit in formation of an image in the VDP 315.

The microcomputer 45 is connected with a voice circuit 32 through the I/O interface 46. The voice circuit 32 is connected with the speakers 22. The speakers 22 are provided on the right and left sides of the main monitor 21, and output a sound under output-control by the voice circuit 32, based on a drive signal from the CPU 41.

The microcomputer 45 is connected with an indicator driving circuit 33 through the I/O interface 46. The indicator driving circuit 33 is connected with the indicator 23. The indicator 23 is provided on the top of the main monitor 21, and displays information regarding a game in general, and the like, under display-control by the indicator driving circuit 33, based on a drive signal from the CPU 41.

The microcomputer 45 is connected with a switch circuit 34 through the I/O interface 46. The switch circuit 34 is connected with the switch 24. The switch 24 is provided below the main monitor 21, and inputs a command by a setting operation performed by an operator into the CPU 41, based on a switch signal from the switch circuit 34.

The microcomputer 45 is connected with a random number generator 35 through the I/O interface 46. The random number generator 35 generates a random number to be sampled by the CPU 41. The microcomputer 45 is connected with a timer 37 through the I/O interface 46. The timer 37 is used for measuring time at the start of a race, and the like.

The microcomputer 45 is connected with the external storage device 25 through the I/O interface 46. The external storage device 25 is provided on the periphery of the main monitor 21.

Further, for example, storing the dot data for forming an image and the like into the external storage device 25 allows the external storage device 25 to have a function similar to that of the image ROM 312 inside the image processing circuit 31. Therefore, when determining an image to be displayed to the main monitor 21, the image control CPU 313 inside the image processing circuit 31 also takes the dot data and the like previously stored inside the external storage device 25 as objects for the determination.

The microcomputer 45 is connected with the communication interface 36 through the I/O interface 46. The communication interface 36 is connected with a sub control portion 102 of each of the stations 101. Therefore, the CPU 41 transmits and receives a command, a request, data, and the like, to and from each of the stations 101 through the communication interface 36.

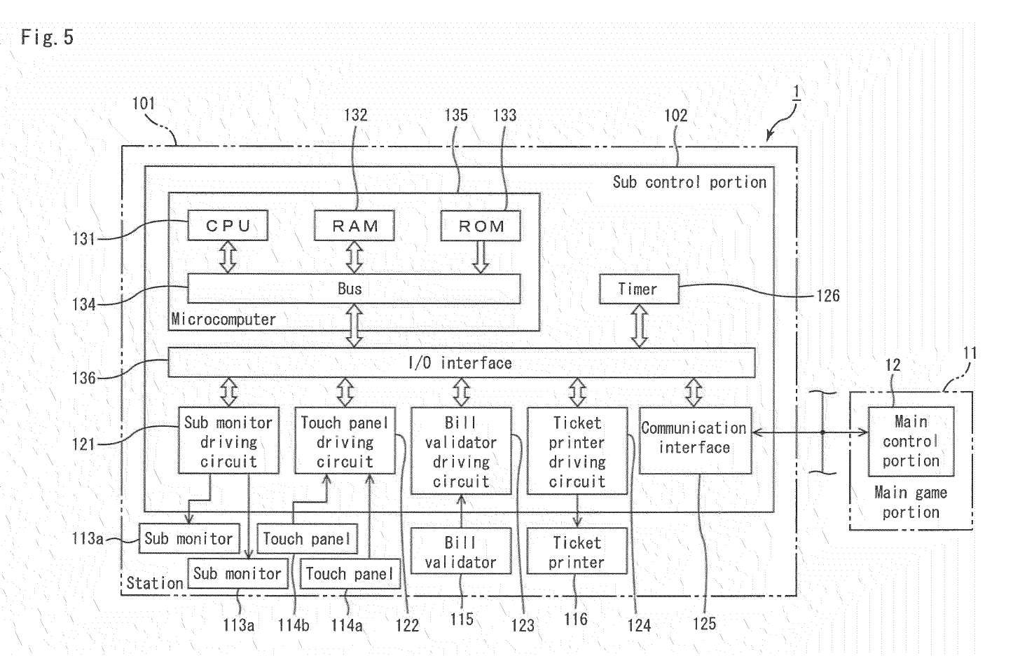

FIG. 5 is a block diagram showing an internal configuration of the station provided in the horse racing game apparatus shown in FIG. 2.

The station 101 includes the sub control portion 102, the sub monitors 113a and 113b, the touch panels 114a and 114b, the bill validator 115, and the ticket printer 116.

The sub control portion 102 has the microcomputer 135 arranged on the circuit board, as a main constituent. The microcomputer 135 has a CPU 131 that performs a control operation in accordance with a previously set program, a RAM 132, and a ROM 133.

The RAM 132 is a memory for temporarily storing a variety of data computed in the CPU 131. The ROM 133 stores a variety of programs for performing processing necessary in controlling the horse racing game apparatus 1, a data table, and the like.

The microcomputer 135 is connected with a sub monitor driving circuit 121 through an I/O interface 136. The sub monitor driving circuit 121 is connected with the sub monitors 113a and 113b. The sub monitor driving circuit 121 controls the drive of the sub monitors 113a and 113b, based on a drive signal from the main game portion 11. The sub monitor driving circuit 121 has a configuration and function similar to those of the image processing circuit 31, and for example, controls the drive of the sub monitors 113a and 113b so that a BET image 200a or a bingo image 200b are displayed.

The microcomputer 135 is connected with a touch panel driving circuit 122 through the I/O interface 136. The touch panel driving circuit 122 is connected with the touch panels 114a and 114b. The touch panels 114a and 114b are provided on the screen of the sub monitors 113a and 113b, and inputs into the CPU 131 a command by a touching operation of the player as a coordinate signal from the touch panel driving circuit 122.

The microcomputer 135 is connected with a bill validator driving circuit 123 through the I/O interface 136. The bill validator driving circuit 123 is connected with the bill validator 115. The bill validator 115 identifies validity of a bill and the ticket 39 with a barcode. When accepting a regular bill, the bill validator 115 inputs the amount of the accepted bill into the CPU 131, based on an identification signal from the bill validator driving circuit 123. Further, when accepting a regular ticket 39 with a barcode, the bill validator 115 inputs into the CPU 131 the number of credits and the like which are recorded on the ticket 39 with a barcode, based on an identification signal from the bill validator driving circuit 123.

The microcomputer 135 is connected with a ticket printer driving circuit 124 through the I/O interface 136. The ticket printer driving circuit 124 is connected with the ticket printer 116. The ticket printer 116 prints on a ticket a barcode formed by encoding data such as the number of owned credits stored in the RAM 132, and the like, and outputs the ticket as the ticket 39 with a barcode under output-control by the ticket printer driving circuit 124, based on a drive signal outputted from the CPU 131.

The microcomputer 135 is connected with a communication interface 125 through the I/O interface 136. The communication interface 125 is connected with the main control portion 12 of the main game portion 11. Therefore, the CPU 131 transmits and receives a command, a request, data, and the like, to and from the main game portion 11 through the communication interface 125.

The microcomputer 135 is connected with the timer 126 through the I/O interface 136. The timer 126 is used for measuring time in ending acceptance of the bet operation.

FIG. 6 is a view schematically showing an example of bet images displayed to the sub monitor. The bet image 200a displayed to the screen of the sub monitor 113a covered by the touch panel 114a is provided with: a horse number display region 201; a horse name display region 202; a basic ability display region 203 displaying speed and stamina by means of bar charts; a record display region 204 displaying orders of finish in last five races; a condition display region 205 displaying current conditions by means of arrows; and a betting ticket purchase button region 206 displaying, with odds and number of bets, a betting ticket perchance button for quinella in which a combination of horse numbers that will finish first and second in any order is predicted.

Further, the bet image 200a includes images of a help button 211, a 1-bet button 213, a 5-bet button 214, a 10-bet button 215, a 50-bet button 216, a cancel button 217, a cash-out button 218, and a betting ticket system switch button 222.

Moreover, the bet image 200a is provided with a time display region 212, a number-of-bets display region 219, an amount-of-payout display region 220, and a number-of-credits display region 221.

The help button 211 is a button to be touched by the player for displaying an operation method for betting and the like to the sub monitor 113a. In the time display region 212, remaining time possible for bet-input is displayed. The 1-bet button 213 is a button to be touched by the player for adding “1” to the current number of bets. The 5-bet button 214 is a button to be touched by the player for adding “5” to the current number of bets. The 10-bet button 215 is a button to be touched by the player for adding “10” to the current number of bets. The 50-bet button 216 is a button to be touched by the player for adding “50” to the current number of bets.

The cancel button 217 is a button to be touched by the player for canceling the added number of bets. The cash-out button 218 is a button to be touched by the player for paying out coins in number in accordance with the number of credits owned by the player by means of the ticket 39 with a barcode. In the number-of-bets display region 219, the total number of bets set by the player in the current race is displayed. The amount-of-payout display region 220 displays an amount of payout in the race this time around. In the number-of-credits display region 221, the number of credits owned by the player is displayed.

Although the bet image shown in FIG. 6 is the quinella bet image, every time a betting ticket system switch button 222 is touched, the bet image is switched to win, place, exacta, trifecta, bracket quinella, trio, quinella-place (wide), and the like.

The player touches any of the 1-bet button 213, the 5-bet button 214, the 10-bet button 215, and the 50-bet button 216, and then touches any betting ticket purchase button within the betting ticket purchase button display region 206, so as to place a bet. For example, when touching the 10-bet button 215 and then touching a “1-2” betting ticket purchase button within the betting ticket purchase button display region 206, the player can add “10” to the current number of bets on “1-2”. Here, “1-2” means that a combination of No. 1 horse and No. 2 horse will take first and second place in any order. It is to be noted that the current number of bets on each combination of horse numbers is displayed next to the betting ticket purchase button corresponding to each combination.

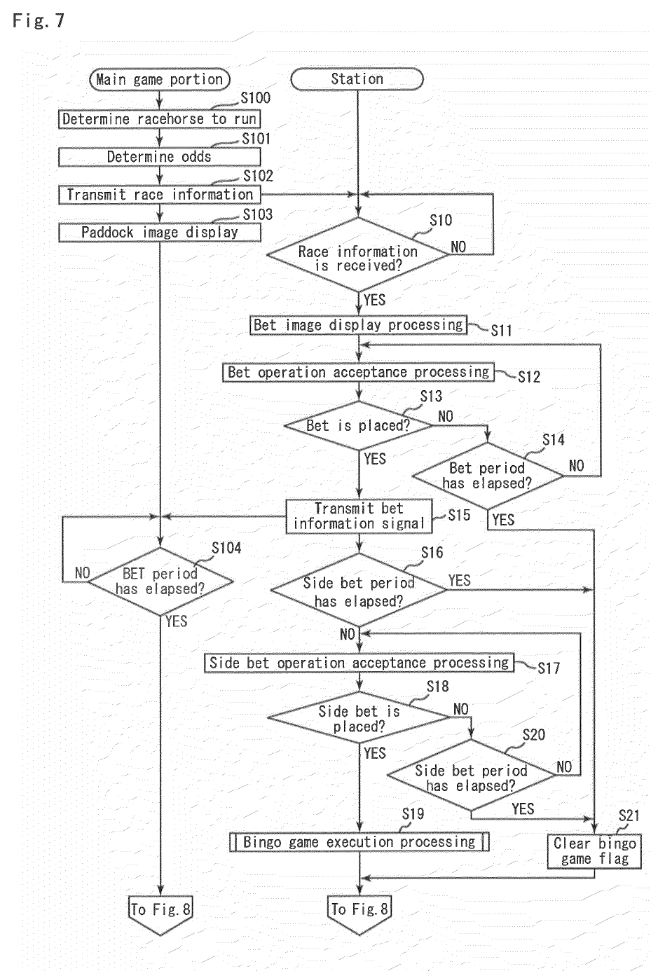

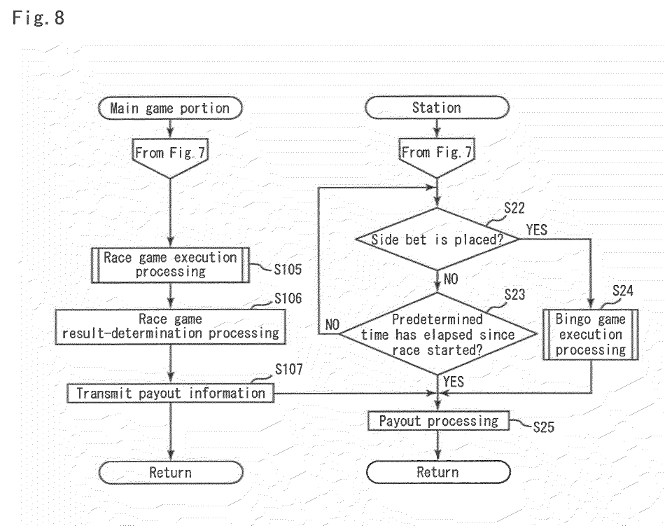

FIGS. 7 and 8 are flowcharts showing an example of game operations in the horse racing game apparatus in the present embodiment.

Processing in the main game portion is executed by the main control portion 12. On the other hand, processing in the station 101 is executed by the sub control portion 102. When the main control portion 12 and the sub control portion 102 cooperate to execute the processing shown in FIGS. 7 and 8, the main control portion 12 and the sub control portion 102 function as the controller of the present invention.

In the main game portion 11, respective operations of steps S100 to S107 are performed.

First, in step S100, the CPU 41 selects information regarding a prescribed number of (e.g. 6) racehorses out of information regarding a plurality of racehorses stored in the ROM 43, based on random numbers generated by the random number generator 35, and determines those horses as racehorses to run in a race this time around. At this time, the CPU 41 provides starting numbers of “1” to “6” to the racehorses to run.

Next, in step S101, the CPU 41 executes processing of determining odds per betting ticket system. At this time, the CPU 41 sets odds, based on winning percentage data of each racehorse which is stored in the ROM 43. Therefore, order-of-finish prediction odds including a racehorse with a high winning probability are set low, whereas order-of-finish prediction odds including a racehorse with a low winning probability are set high.

In step S102, the CPU 41 transmits, to each station 101, race information on the racehorses to run (starter) and odds which have been determined in the processing of steps S100 and S101.

In step S103, the CPU 41 makes the VDP 315 display a paddock image on the main monitor 21. In this processing, the CPU 41 supplies the image processing circuit 31 with information showing a good condition of the horse to run determined in step S100. The VDP 315 generates an image showing the good condition of the racehorse to run based on the information, and displays the image to the main monitor 21 (see FIG. 2).

Next, in step S104, the CPU 41 determines whether or not the BET period has been expired. Specifically, the CPU 41 determines whether or not prescribed time has elapsed based on information on the time measured by the timer 37.

When determining that the BET period has not been expired, the CPU 41 returns the processing to step S104. On the other hand, when determining that the BET period has been expired, the CPU 41 shifts the processing to step S105.

In step S105, the CPU 41 executes racing game execution processing.

In this racing game execution processing, the VDP 315 determines an order of finish of each racehorse in the racing game, based on a random number generated by the random number generator 35. The CPU 41 then output an image showing the race status to the main monitor 21, based on the determined order of finish of each racehorse.

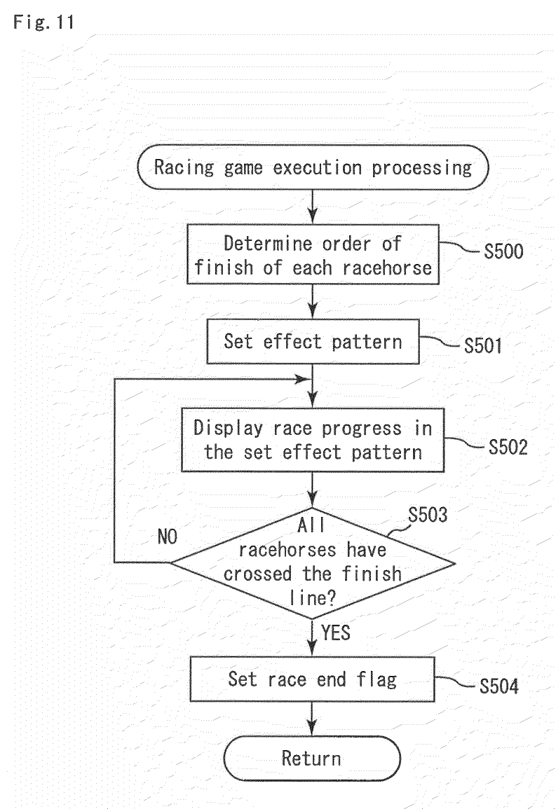

This racing game execution processing is detailed later using FIG. 11.

In step S106, the CPU 41 calculates an amount of payout for each station 101, based on the order of finish of each racehorse which has been determined in the racing game execution processing of step S105 and on a bet information signal transmitted from each station 101 in later-described processing of step S15.

Next, in step S107, the CPU 41 transmits each of the amounts of payout calculated in the processing of step S106 as payout information to each corresponding station 101.

Hereafter, the same processing is repeated in subsequent races.

Meanwhile, in each of the stations 101, respective operations of steps S10 to S25 are performed.

First, in step S10, the CPU 131 determines whether or not race information has been received from the main game portion 11. When determining that the information has not been received, the CPU 131 returns the processing to step S10. On the other hand, when determining that the information has been received, the CPU 131 shifts the processing to step S11.

In step S11, the CPU 131 displays the bet image 200a to the sub monitor 113a based on the race information transmitted by the CPU 41 (see FIG. 1(a) and FIG. 6).

In step S12, the CPU 131 executes bet operation-accepting processing. Specifically, the CPU 131 specifies contents of the bet operation performed by the player based on a coordinate signal from the touch panel driving circuit 122, and stores the contents into the RAM 132. Further, the CPU 131 reflects the contents of the bet operation to the display on the bet image 200a of the sub monitor 113a.

In step S13, the CPU 131 determines whether or not a BET has been placed. When determining that the BET has been placed, the CPU 131 shifts the processing to step S15. On the other hand, when determining that the BET has not been placed, the CPU 131 shifts the processing to step S14.

In step S14, the CPU 41 determines whether or not the BET period has been expired. Specifically, the CPU 131 determines whether or not prescribed time (3 minutes in the present embodiment) has elapsed after the start of acceptance of the BET operation in step S12 based on the information on the time measured by the timer 126. When determining that the BET period has not been expired, the CPU 131 returns the processing to step S12. On the other hand, when determining that the BET period has expired, the CPU 131 shifts the processing to step S21.

Instep S15, the CPU 131 transmits bet information showing the contents of the bet operation as bet information signal to the main control portion 12 through the communication interface 125. The bet information signal includes at least the race horse ID on which bet has been placed, the number of bet of game media, information regarding the type of a betting ticket, and an identification number of the station 101.

In step S16, the CPU 131 determines whether or not a side BET period has been expired based on the information on the time measured by the timer 126. The side BET period is a period when a BET can be placed on the bingo game.

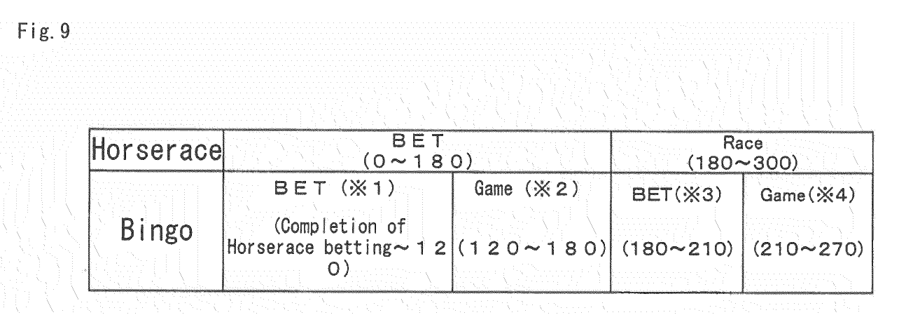

Here, the side BET period is described using FIG. 9.

FIG. 9 is a view showing time tables for the horse racing game and the bingo game.

The numbers in the figure show the time (seconds) after the start of acceptance of the BET operation on the racing game (see step S12 of FIG. 7). Namely, the BET period for the horse racing game is 3 minutes, from 0 to 180 seconds. Further, the race time for the horse racing game is 2 minutes, from 180 to 300 seconds.

As shown in *1, the BET period for the bingo game, namely the side BET period, is within 120 seconds after the completion of the BET on the horse racing game. Here, “completion of the BET on the horse racing game” means a condition in which a BET of at least 1 credit or more has been placed.

The side BET period in step S16 of FIG. 7 refers to this period.

In the following, a description is given with properly reference to the time table shown in FIG. 9.

When determining that the side BET period has been expired in step S16, the CPU 131 shifts the processing to step S21. On the other hand, when determining that the side BET period has not been expired, the CPU 131 shifts the processing to step S17.

In step S17, the CPU 131 performs side BET operation acceptance processing. Specifically, the CPU 131 displays the notification image 200d and the bingo BET button image 200e, shown in FIG. 1B, on the sub-monitor 113b. The player can touch the touch panel 114b on the bingo BET button image 200e, to place a BET (side BET, 1 credit in the present embodiment) on the bingo game.

The processing of step S17 corresponds to the processing (C′) in the present invention. Further, step S17 corresponds to the stop (C′) in the present invention.

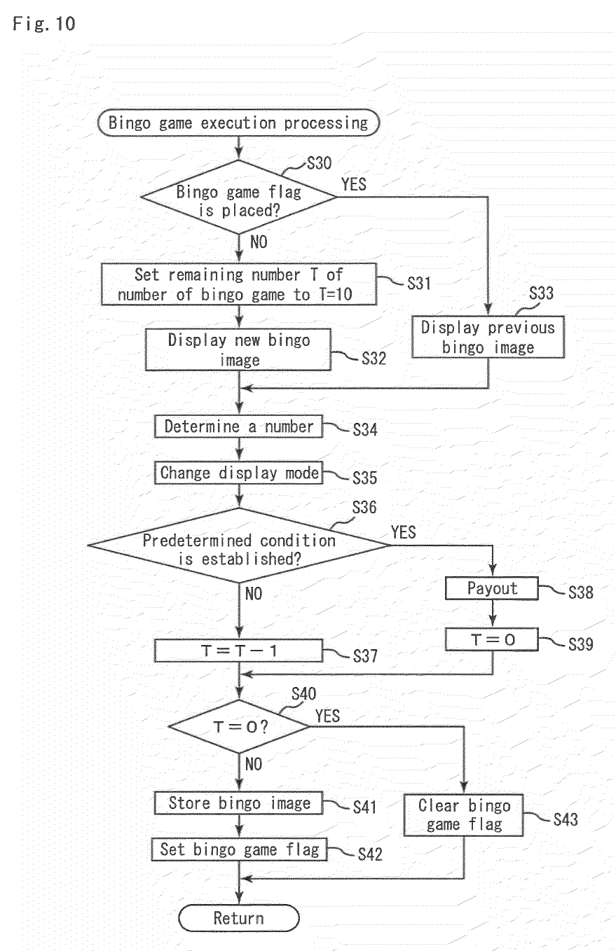

Next, in step S18, the CPU 131 determines whether or not a side BET has been placed. When determining that the side BET has been placed, the CPU 131 shifts the processing to step S19, and executes the bingo game execution processing. The bingo game execution processing is detailed later using FIG. 10.

It is to be noted that, as shown in *2 in FIG. 9, here, the bingo game execution processing is performed during a period of 120 to 180 seconds after the start of acceptance of the BET operation on the horse racing game. At the timing of the completion of the bingo game execution processing, the race of the horse racing game is arranged to start.

On the other hand, when determining that the side BET has not been placed, the CPU 131 shifts the processing to step S20.

In step S20, the CPU 41 determines whether or not the side BET period has been expired based on the information on the time measured by the timer 126. Since the side BET period is as described in step S16, a description thereof is omitted here.

When determining that the side BET period has not been expired, the CPU 131 returns the processing to step S17. On the other hand, when determining that side BET period has been expired, the CPU 131 shifts the processing to step S21.

When determining that side BET period has been expired in step S20 or step S16, or when determining that the BET period has been expired in step S14, the CPU 131 clears a bingo game flag in a case where the bingo game flag has been set (step S21). The bingo game flag is a flag that is set when the bingo game is played (see step S42 of FIG. 10).

As thus described, the present embodiment is configured such that the bingo game flag is cleared when the side BET has not been placed during the BET period for the horse racing game.

After executing the processing of step S21 or S19, the CPU 131 performs the side BET operation acceptance processing, and determines whether or not the side BET has been placed (step S22). As shown in *3 of FIG. 9, here, the side BET operation acceptance processing is performed during a period of 180 to 210 seconds after the start of acceptance of the race of the horse racing game. This period corresponds to 30 seconds after the start of the race of the horse racing game.

Processing in step S22 correspondents to the processing (C′) of the present invention. Further, step S22 correspondents to the step (C′) in the present invention.

When determining that the side BET has been placed, the CPU 131 executes the bingo game execution processing in step S24. As shown in *4 of FIG. 9, here, the bingo game execution processing is performed during a period of 210 to 270 seconds after the start of the acceptance of the BET operation on the horse racing game. When the bingo game ends, the race remaining time is 30 seconds.

On the other hand, when determining that the side BET has not been placed, the CPU 131 shifts the processing to step S23.

In step S23, the CPU 131 determines whether or not the side BET period has been expired, namely, 30 seconds has elapsed after the start of the race of the horse racing game, based on the information on the time measured by the timer 126. When determining that the side BET period has not been expired, the CPU 131 returns the processing to step S22. On the other hand, when determining that the side BET period has been expired, the CPU 131 shifts the processing to step S25.

In step S17, based on payout information transmitted from the main game portion 11, the CPU 131 updates the number of credits owned by the player which is stored in the RAM 132, and also updates display in the amount-of-payout display region 220 and the number-of-credits display region 221 on the bet image of the sub monitor 113.

In step 25, based on payout information (see step S107) transmitted from the main game portion 11, the CPU 131 updates the number of credits owned by the player that is stored in the RAM 132, and also updates display in the amount-of-payout display region 220 and the number-of-credits display region 221 on the bet image 200a of the sub monitor 113. After executing processing of step S25, the CPU 131 terminates the present subroutine.

Subsequently, the bingo game execution processing is described using FIG. 10.

FIG. 10 is a flowchart showing a subroutine of the bingo game execution processing performed in the sub-control portion.

First, the CPU 131 determines whether or not the bingo game flag has been set (step S30). Here, “the bingo game flag has been set” means that the bingo game was played during the BET period for the previous horse racing game or during the race of the previous racing game (see step S42). When determining that the bingo game flag has been set in step S30, the CPU 131 displays the bingo image 200b showing the status of the previous bingo game to the sub-monitor 113b (step S33). It is to be noted that the bingo image 200b showing the status of the previous bingo game has been stored in the RAM 132 in step S41 of the previous bingo game execution processing.

On the other hand, when determining that the bingo game flag has not been set, the CPU 131 sets the remaining number T of bingo games to “T=10”, and stores the data into the RAM 132 (step S31).

The CPU 131 then displays a new bingo image 200b (with the display mode of any cell unchanged) to the sub-monitor 113b (step S32). The CPU 131 generates bingo image data based on cell data showing the cells of five rows and five columns stored in the ROM 133 and 25 numbers determined based on random numbers, and supplies the bingo image data to the sub-monitor driving circuit 121. Accordingly, the CPU 131 displays the bingo image 200b to the sub-monitor 113b.

As described in step S21 of FIG. 7, the present embodiment is configured such that the bingo game flag is cleared when a side BET is not placed on the bingo game during the BET period for the horse racing game. Therefore, the previous bingo game is continued only when the side BET has been placed on the bingo game during the BET period for the horse racing game.

After execution of the processing of step S32 or S33, the CPU 131 determines one number by means of random numbers (step S34). The CPU 131 then controls the sub-monitor driving circuit 121 such that the display mode of a cell in which the determined number is arranged changes in the bingo image 200b (step S35) The processing of steps S32 to S35 corresponds to the processing (D) in the present invention. Further, steps S32 to S35 correspond to the step (D) in the present invention.

Next, the CPU 131 determines whether or not the prescribed condition has been established, namely, whether or not a vertical, horizontal or oblique line has been formed (step S36) When determining that the prescribed condition has not been established, the CPU 131 sets the value of T stored in the RAM 132 to “T=T−1” (step S37).

On the other hand, when determining that the prescribed condition has been established, the CPU 131 offers a payout based on the value of T (step S37). Namely, the CPU 131 updates the number of credits owned by the player which is stored in the RAM 132. The present embodiment is configured such that the larger the value of T, namely the smaller the number of games required until the completion of the bingo, the larger the amount of payout becomes.

Subsequently, the CPU 131 sets the value of T stored in the RAM 132 to “T=0” (step S39).

After executing the processing of step S37 or S39, the CPU 131 determines whether or not T is 0 (step S40). When determining that T is 0, the CPU 131 clears the bingo game flag (step S43), and terminates the present subroutine.

On the other hand, when determining that T is not 0, the CPU 131 stores the bingo image 200b, the display mode of which was changed in step S35, in the RAM 132 (step S41). When the bingo game flag has not been set, the CPU 131 sets the bingo game flag (step S42), and terminates the present subroutine.

The bingo game execution processing described here corresponds to the processing (C) in the present invention. Further, steps S30 to S42 correspond to the step (C) in the present invention.

The FIG. 11 is a flowchart showing a subroutine of a racing game execution processing performed in the main control portion.

First, in step S500, the CPU 41 determines popularity ranking of each of the racehorses in a racing game based on the random number generated by the random number generator 35.

In step S501, the CPU 41 sets an effect pattern for image display, based on the order of each racehorse determined in the processing of step S500. The CPU 41 then supplies the set effect pattern to the image processing circuit 31.

The VDP 315 of the image processing circuit 31 generates effect image data of each racehorse from the start to the goal based on the supplied effect pattern and background image data, image data of the racehorse, and the like, which are stored in the image ROM 312. The VDP 315 then outputs an image showing the progress of the race to the main monitor 21 based on the effect image data generated in the processing of step S501.

Further, the effect image data is supplied from the VDP 315 to the sub-control portion 102 of the station 101 through the CPU 41. The CPU 131 outputs the effect image data to the sub-monitor 113a, which results in display of the race image 200c to the sub-monitor 113a. The processing, in which the CPU 131 performs a control such that the race image 200c is displayed to the sub-monitor 113a, corresponds to the processing (B) in the present invention. Further, step S502 corresponds to the step (B) in the present invention.

Next, in step S503, the CPU 41 determines whether or not all racehorses to run in the racing game have reached the goal, namely, whether or not prescribed time (2 minutes in the present embodiment) has elapsed after the start of the race. When determining that not all the racehorses have reached the goal, the CPU 41 returns the processing to step S502. On the other hand, when determining that all the racehorses have reached the goal, the CPU 41 shifts the processing to step S504.

In step S504, the CPU 41 sets a race end flag. It is to be noted that the race end flag is a flag to be set at the end of the race and cleared when racehorses to run in a next race are determined.

After execution of the processing of step S504, the CPU terminates the present sub routine.

The racing game execution processing shown in FIG. 11 corresponds to processing (A) in the present invention, and step S500 to step S504 correspond to the step (A) in the present invention.

As described above, according to the horse racing game apparatus 1 of the present embodiment, the station 101 provided in the horse racing game apparatus 1 has two monitors, the sub-monitor 113a and the sub-monitor 113b. A racing game in which a plurality of racehorses contend with one another for winning proceeds, and the race image 200c showing the status of the race is displayed to the sub-monitor 113a. Further, the BET image 200a where a BET on the horse racing game can be placed is also displayed to the sub-monitor 113a.

Meanwhile, on the sub-monitor 113b provided in the station 101 where the BET has been placed on the horse racing game during the BET period for the horse racing game or the during the race, the notification image 200d notifying the player that the bingo game can be played and the bingo BET button image 200e for placing a BET on the bingo game are displayed. When a BET is placed on the bingo game, the bingo game is executed at the station 101 where the BET is placed. The bingo image 200b showing the status of the bingo game is displayed to the sub-monitor 113b.

According to the horse racing game apparatus 1 of the present embodiment, for example, a player who has completed a BET input before the end of the BET period due to little interest in carefully selecting a horse to bet on, or a player who is not interested in the intermediate status of a race and just wants to know a race result (i.e. a player having a primary interest in a payout of game media), can play a bingo game at his or her option by looking at an image relating to the bingo game displayed to the sub-monitor 113b provided in the station 101. It is therefore possible to prevent such a player from getting bored.

Further, since the player can enjoy the bingo game, the player less often leaves the racing gaming apparatus 1 with coins left credited to play a game in another gaming apparatus. It is thus possible to prevent the player from having the credited coins stolen.

Further, the horse racing game apparatus 1 of the present embodiment is configured such that the bingo game flag is cleared when the side BET is not placed on the bingo game during the BET period for the horse racing game. Therefore, the previous bingo game is continued only when the side BET is placed on the bingo game during the BET period for the horse racing game.

For this reason, in order to continue the bingo game, the player also needs to place a BET on the bingo game during each BET period for the horse racing game. Hence it is possible to make the player feel that he should not fail to place a BET on the bingo game, so as to further prevent the player from leaving the horse racing game apparatus 1.

Further, according to the horse racing game apparatus 1 of the present embodiment, unless a bingo is completed within 10 games after the start of the bingo game, the bingo game flag is cleared and a bingo game is started again by a new image 200b. Moreover, a payout amount for the bingo game is determined such that the smaller the number of games required until the completion of the bingo, the larger the payout amount becomes.

Therefore, the player needs to complete the bingo within 10 games so as to receive a payout in the bingo game. The player can acquire a larger payout when completing the bingo at as earlier a stage as possible.

Therefore, according to the horse racing game apparatus 1 of the present embodiment, it is possible to make the player absorbed in establishing the bingo as soon as possible, thereby making it possible to provide a game that can prevent a player from getting bored of the game.

Further, the horse racing game apparatus 1 of the present embodiment is configured such that, while the horse racing game is played one time, the bingo game is played twice at prescribed timings during the BET period and during the race. Since the relation between the time when the horse racing game is played and the time when the bingo game is played is clear, it is possible to make the player feel that the horse racing game and the bingo game are on progress as one united game. It is therefore possible to provide an extremely attractive game that prevents the player from getting bored of the game.

Further, according to the horse racing game apparatus 1 of the present embodiment, the station 101 is provided with both the sub-monitor 113a capable of displaying an image relating to the racing game and the sub-monitor 113b capable of displaying an image relating to the bingo game. Therefore, it is possible for the player to simultaneously have the image relating to the racing game and the image relating to the bingo game in sight, and thus not necessary to shift his or her eyes between the monitor (main monitor 21) installed at a place other than the station and the sub-monitor 133b provided in the station 101, so as to always grasp with precision the status of both the racing game and the bingo game. It is therefore possible to prevent the player from missing an important scene such as the goal of the racehorses.

Further, according to the horse racing game apparatus 1 of the present embodiment, the bingo game that is played during the race ends at the time point when the remaining time for the race is 30 seconds. As thus described, a fixed time interval is provided between the end of the bingo game and the end of the race, whereby it is possible to further reduce the possibility that the player will miss an important scene such as the goal of the racehorses.

The gaming apparatus of the present invention may be configured such that each player can operate the input device such as the touch panel, to make a scene he or she wishes to see displayed to the sub-monitor. For example, it may be configured such that the player can make an image, showing a condition of a racehorse of his or her interest in a paddock, displayed to the sub-monitor. With such a configuration adopted, an image meeting each player's request can be displayed, thereby making it possible to provide the player with satisfaction.

Further, according to the horse racing game apparatus 1 of the present embodiment, a BET on the bingo game is accepted only at the station 101 where the BET has been placed on the horse racing game. The bingo game is then executed on condition that the BET has been placed on the bingo game.

Therefore, only a player who has placed a BET on the horse racing game can play the bingo game. It is thereby possible to eliminate a player who intends to play only the bingo game, so as to prevent a player who concentrates on the horse racing game from being offended, while avoiding a state in which the gaming apparatuses are exclusively used by players who play only the bingo game and thus other players cannot participate in the horse racing game.

In the present embodiment, an amount of BET on the bingo game is one credit. However, in the present invention, an amount of BET on the side game is not limited to this example. For example, a condition of betting a prescribed amount or higher may be set as a condition for playing the side game. With such a configuration adopted, it is possible to expand a profit of the gaming facility.

In the present embodiment, the bingo game is played as the side game. However, the side game in the present invention is not limited to this example. As the side game in the present invention, a game such as a card game like Poker or Blackjack, Sport Book Game, Roulette Game, or the like can be applied as appropriate.

In the present embodiment, the case of applying the present invention to the horse racing game apparatus 1 has been described, but in the present invention, a bike racing game apparatus, a boat racing game apparatus, a dog racing game apparatus, a car racing game apparatus, a motorcycle racing game apparatus, or the like may be adopted. In the case of forming such a configuration, bikes, motorboats, dogs, cars, or motorcycles correspond to the race objects in the present invention.

Although the embodiment of the present invention has been described above, it just presents a specific example, and does not particularly limit the present invention. A specific configuration of each unit or the like can be appropriately changed in terms of design. Further, the description of the effects made in the embodiment of the present invention are only recitation of the most preferable effects that arise from the present invention, and the effects according to the present invention are not limited to those described in the embodiment of the present invention.

What is claimed as new and desired to be secured by Letters Patent OF THE UNITED STATES IS:

1. A gaming apparatus, comprising:
a display capable of displaying an image relating to a racing game in which a plurality of race objects contend with one another for winning;
one or a plurality of stations at least having a side display capable of displaying an image relating to a side game which is different from said racing game and an input device with which a player can input a command; and
a controller,
said controller programmed to execute the processing of
(A) proceeding with said racing game,
(B) displaying to said display an image relating to said racing game which proceeds in execution of said processing (A),
(C) executing, when a command to play said side game is inputted from said input device during the time when the racing game executed in said processing (A) is proceeding or during the time from the end of one racing game before the start of a next racing game, said side game in the station having said input device, and
(D) displaying an image relating to the side game executed in said processing (C) to said side display provided in said station.

2. The gaming apparatus according to claim 1,
wherein
said display is provided in each of said stations.

3. The gaming apparatus according to claim 1,
wherein
said input device is an input device with which a player can input a BET on said racing game and said side game,
said controller is further programmed to execute processing of:
(A′) accepting a BET on said racing game from each of said input devices; and
(C′) accepting a BET on said side game from the input device, from which the BET on the racing game was inputted in said processing (A′), in the station having said input device, and
said processing (C) is processing of executing, on condition that the BET has been placed on the side game from the input device in said processing (C′), the side game in the station having the input device, from which the BET on the side game was inputted.

4. A game control method, comprising the steps of:
(A) proceeding with a racing game in which a plurality of race objects contend with one another for winning;
(B) displaying to a display an image relating to said racing game which proceeds in execution of said step (A);
(C) executing a side game which is different from said racing game in a station into which a command to play said side game has been inputted when said command is inputted during the time when the racing game executed in said step (A) is proceeding or during the time from the end of one racing game before the start of a next racing game; and
(D) displaying an image relating to the side game executed in said step (C) to a side display which is different from said display and is provided in said station.

5. The game control method according to claim 4, including the steps of:
(A′) accepting a BET on said racing game; and
(C′) accepting a BET on said side game in a station where the BET has been placed on the racing game in said step (A′),
wherein
said step (C) is a step of executing the side game in the station where the BET has been placed on the side game on condition that the BET has been placed on the side game in said step (C′).
